(19) United States
(12) Patent Application Publication
(10) Pub. No.: US 2026/0346937 A1
(43) Pub. Date: Nov. 5, 2026

(54) CONNECTION STRUCTURE OF FUEL CELL IN HUMAN-POWERED ELECTRICALLY ASSISTED VEHICLE

(71) Applicant: TOYOTA BOSHOKU KABUSHIKI KAISHA, Aichi-ken (JP)

(72) Inventors: Haruyuki AONO, Aichi-ken (JP); Satoshi KAWABE, Ichinomiya-shi (JP)

(73) Assignee: TOYOTA BOSHOKU KABUSHIKI KAISHA, Aichi-ken (JP)

(21) Appl. No.: 19/486,144

(22) PCT Filed: May 17, 2024
(86) PCT No.: PCT/JP2024/018312

§ 371 Date: Nov. 20, 2025

(30) Foreign Application Priority Data
May 30, 2023 (JP) 2023-088467

(51) Int. Cl. B62J 43/28; B62J 43/13; B62M 6/40; B62M 6/80; H01M 8/04119; H01M 8/2484

(52) U.S. Cl. CPC B62J 43/28; B62J 43/13; B62M 6/40; B62M 6/80; H01M 8/04156; H01M 8/2484; H01M 2250/20

(57) ABSTRACT

A connection structure for a fuel cell in a human-powered electrically assisted vehicle includes a connection mechanism. The connection mechanism connects the fuel cell in a manner allowing the fuel cell to swing relative to a body frame and restricts changes in orientation of the fuel cell so that an inclination from an upright position, at which the vehicle is held upright on a level plane, of the fuel cell is less than that of the body frame.

### TECHNICAL FIELD

The present disclosure relates to a connection structure for a fuel cell in a human-powered electrically assisted vehicle.

### BACKGROUND ART

Patent Literature 1 discloses an electrically assisted bicycle (hereafter, “bicycle”). The bicycle disclosed in Patent Literature 1 includes a frame, a drive shaft attached to the frame, a crank rotatably supported by the axle, and an electric motor connected to the drive shaft to assist in rotational driving of the crank. Further, the bicycle includes a fuel cell that generates electric power supplied to the electric motor and a casing for holding the fuel cell. The frame includes a seat tube that supports a saddle, a head tube that supports a handlebar, and a top tube and a down tube that connect the seat tube and the head tube. The casing is fixed to a part of a front surface of the seat tube between the top tube and the down tube. The fuel cell includes a stack of unit cells. The unit cells are stacked in an axial direction of the seat tube.

In the fuel cell, the electrochemical reaction of reactant gas generates water in a power generation portion of the unit cells. The water generated in this manner (hereinafter, “generated water”) is discharged out of the stack through a manifold hole, which extends through the stack from a gas flow channel of the unit cells, by the flow pressure of the reactant gas supplied to the unit cell and the weight of the generated water.

### CITATION LIST

### Patent Literature

Patent Literature 1: WO2021/149800

### SUMMARY OF INVENTION

### Technical Problem

In a conventional human-powered electrically assisted vehicle including the bicycle described in Patent Literature 1, the stack is tilted in orientation relative to the frame when the road surface inclines, when the riding posture of the bicycle changes, or for other reasons. In this case, the tilted orientation of the stack relative to the frame may adversely affect the drainage of the generated water from the unit cells. This, in turn, adversely affects the power generating performance of the fuel cell.

### Solution to Problem

A structure for connecting a fuel cell to a body frame of a human-powered electrically assisted vehicle, in which the vehicle to which the structure is applied includes a drive shaft that drives a wheel with human-power, a motor that applies assist drive force to the drive shaft, and the fuel cell that supplies electric power to the motor includes a connection mechanism connecting the fuel cell in a manner allowing the fuel cell to swing relative to the body frame and restricting changes in orientation of the fuel cell so that an inclination from an upright position, at which the vehicle is held upright on a level plane, of the fuel cell is less than that of the body frame.

### BRIEF DESCRIPTION OF DRAWINGS

FIG. 1 is a side view of an electrically assisted bicycle including a connection mechanism in accordance with a first embodiment.

FIG. 2 is an exploded perspective view of a fuel cell stack.

FIG. 3 is an exploded perspective view of a unit cell shown in FIG. 2.

FIG. 4 is a cross-sectional view of the connection mechanism shown in FIG. 1.

FIG. 5 is a cross-sectional view illustrating the operation of the connection mechanism shown in FIG. 4.

FIG. 6 is a cross-sectional view of a connection mechanism in accordance with a second embodiment.

FIG. 7 is a cross-sectional view illustrating the operation of the connection mechanism shown in FIG. 6.

FIG. 8 is a cross-sectional view illustrating an operation of the connection mechanism shown in FIG. 6.

### DESCRIPTION OF EMBODIMENTS

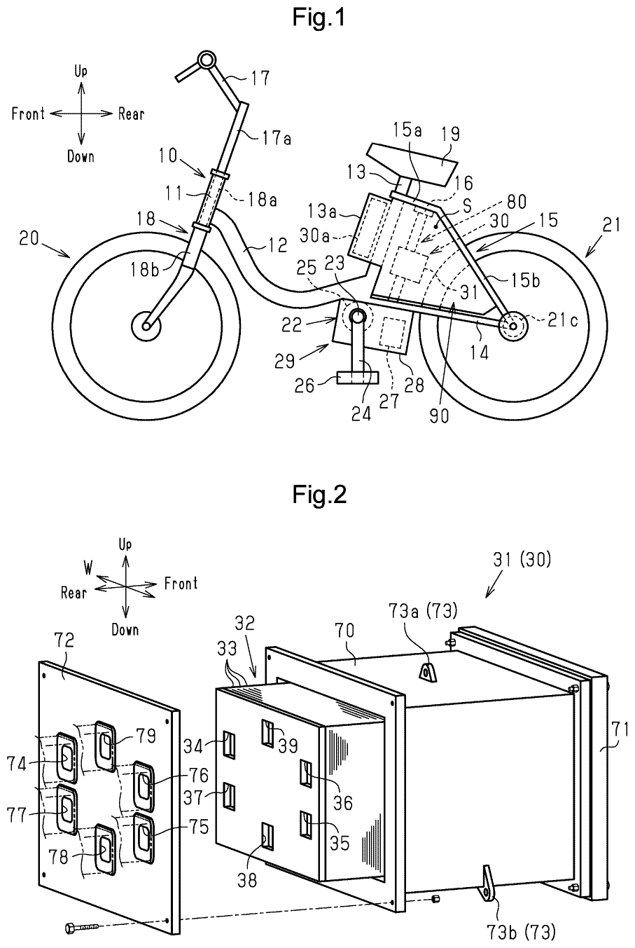

A connection structure for a human-powered electrically assisted vehicle according to a first embodiment will now be described with reference to FIGS. 1 to 5. The connection structure of the electrically assisted bicycle (hereafter, referred to as the bicycle) is employed as the connection structure of the human-powered electrically assisted vehicle in the first embodiment.

### Bicycle

The structure of a bicycle will now be described.

In the description hereafter, the longitudinal direction and the lateral direction of the bicycle will simply be referred to as the longitudinal direction L and the lateral direction W. The front side and the rear side in the longitudinal direction L will simply be referred to as the front side and the rear side. Further, the vertical direction when the bicycle is held upright on a level plane will simply be referred to as the vertical direction Z. The upper side and the lower side in the vertical direction Z will simply be referred to as the upper side and the lower side.

As shown in FIG. 1, the bicycle includes a body frame 10, a handlebar 17, a front fork 18, a saddle 19, a front wheel 20, a rear wheel 21, a drive unit 29, a fuel cell 30, and a connection mechanism 80.

The body frame 10 includes a cylindrical head tube 11 extending in the vertical direction Z, a down tube 12 extending rearward from the rear surface of the head tube 11, and a seat tube 13 extending upward from the rear end of the down tube 12. The body frame 10 also includes two lower frames 14 (see FIG. 4), two upper frames 15 (see FIG. 4), and an attachment portion 16 fixed to the lower surfaces of the two upper frames 15.

The head tube 11 supports the front fork 18 rotatably about the axis of the head tube 11.

A holder 13a is fixed to a front surface of the seat tube 13. The saddle 19 is fixed to an upper end of the seat tube 13.

The two lower frames 14 extend rearward from the rear end of the down tube 12 and are spaced apart from each other in the lateral direction W.

The two upper frames 15 extend rearward from the seat tube 13 and are spaced apart from each other in the lateral direction W. The upper frames 15 each include a first frame 15a extending rearward from an upper portion of the seat tube 13, and a second frame 15b extending rearward from a rear end of the first frame 15a and connected to a rear end of the corresponding lower frame 14. The first frame 15a extends in a direction orthogonal to an extending direction of the seat tube 13. The attachment portion 16 extends in the lateral direction W and is fixed to the lower surfaces of the two first frames 15a.

The front fork 18 includes a tubular basal portion 18a, which is inserted into the head tube 11, and two fork portions 18b, which are spaced apart from each other in the lateral direction W and extend downward from a lower end of the basal portion 18a. The basal portion 18a is supported, rotatably about the axis of the head tube 11, by the head tube 11. A stem 17a extending from the handlebar 17 is fixed to an upper end of the basal portion 18a.

The front wheel 20 is arranged between the two fork portions 18b and is rotatable relative to the fork portions 18b.

The rear wheel 21, which is arranged between the two lower frames 14 and the two upper frames 15, is rotatable relative to the lower frames 14 and the upper frames 15. A sprocket 21c is connected coaxially to the rear wheel 21.

The drive unit 29 is fixed to the lower side of the down tube 12 and the lower frames 14. The drive unit 29 includes a crankset 22, two pedals 26, a housing 28, and a motor 27 accommodated in the housing 28. The crankset 22 includes a drive shaft 23 extending in the lateral direction W, a crank 24 fixed to each of the two ends of the drive shaft 23 in the lateral direction W, and a chainring 25 fixed to each of the two ends of the drive shaft 23 in the lateral direction W.

The drive shaft 23 is supported rotatably by a bearing, which is arranged in the housing 28, about an axis extending in the lateral direction W. The pedals 26 are connected to the cranks 24. The chainrings 25 are linked to the sprocket 21c by a chain (not shown).

The motor 27 applies an assisting driving force to the drive shaft 23. An output shaft of the motor 27 is connected to the drive shaft 23 by a reduction gear (not shown).

### Fuel Cell 30

The fuel cell 30 will now be described.

Referring FIG. 1, the fuel cell 30 generates electric power through an electrochemical reaction and supplies the electric power to the motor 27. The fuel cell 30 includes a canister 30a, a fuel cell stack 31, an air compressor (not shown), and a controller (not shown).

The canister 30a is filled with high-pressure fuel gas to supply the fuel gas to the fuel cell stack 31 through a flexible hose (not shown). The canister 30a is accommodated in the holder 13a.

The air compressor delivers ambient air, which serves as an oxidant gas, to the fuel cell stack 31 through the flexible hose (not shown).

The fuel cell stack 31, the air compressor (not shown), and the controller (not shown), which executes various controls on the fuel cell, are accommodated in an accommodation space S that is surrounded by the seat tube 13, the lower frames 14, the upper frames 15, and the rear wheel 21. The fuel cell stack 31 is connected to the body frame 10 and is accommodated in the housing 90, which is fixed to the body frame 10. The housing 90 is located behind the seat tube 13 and between the upper frames 15 and the lower frames 14.

As shown in FIG. 2, the fuel cell stack 31 includes a stack body 32, a case 70, a front end plate 71, and a rear end plate 72.

The stack body 32 includes inlet holes 34, 36, and 38, which are used to draw the fuel gas, a cooling medium, and the oxidant gas into the stack body 32, and outlet holes 35, 37, and 39, which are used to discharge the fuel gas, the cooling medium, and the oxidant gas out of the stack body 32. The stack body 32 is formed by stacking unit cells 33 in the longitudinal direction L.

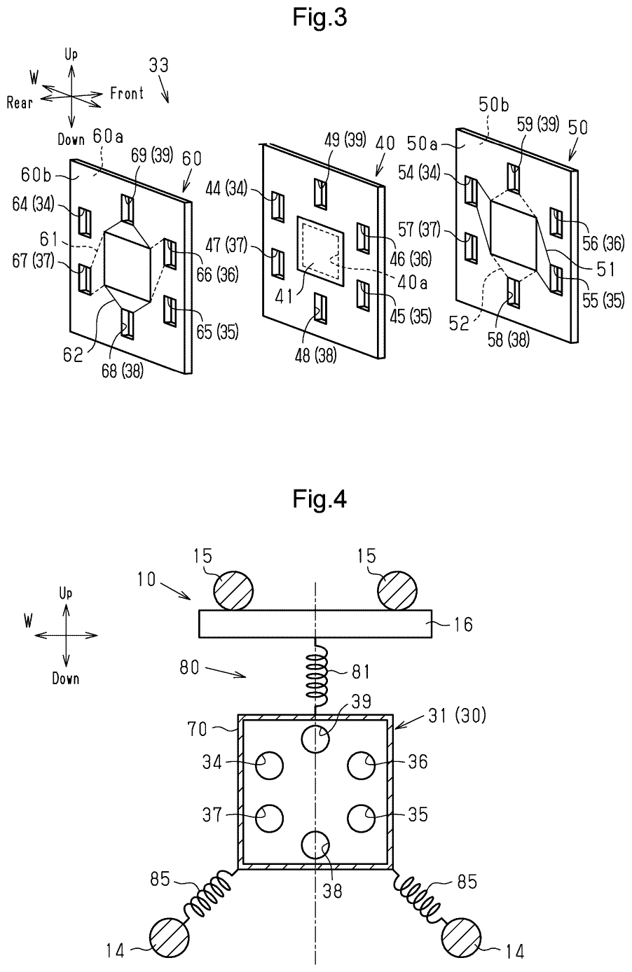

As shown in FIG. 3, each unit cell 33 includes an electric power generator 41, an electrically insulative frame member 40 that surrounds the electric power generator 41, and an anode-side separator 50 and a cathode-side separator 60 that hold the electric power generator 41 and the frame member 40 in between.

The electric power generator 41 includes a polymer electrolyte membrane (not shown; hereinafter referred to as the electrolyte membrane) and electrodes (not shown) arranged on the two surfaces of the electrolyte membrane. The electrodes include catalyst layers (not shown) bonded to the electrolyte membrane and gas diffusion layers (not shown) bonded to the catalyst layers.

The frame member 40 includes through holes 44, 45, 46, 47, 48, and 49 that form the holes 34, 35, 36, 37, 38, and 39, respectively.

The frame member 40 includes a central opening 40a. The outer edges of the electric power generator 41 are bonded to the inner edges of the opening 40a from one side in the longitudinal direction X (the front side in FIG. 3).

The cathode-side separator 60 is arranged on a cathode electrode side (front side as viewed in FIG. 3) of the electric power generator 41.

The cathode-side separator 60 includes a first surface 60a that faces the electric power generator 41, and a second surface 60b that is opposite the first surface 60a.

The cathode-side separator 60 includes through holes 64, 65, 66, 67, 68, and 69, that form the holes 34, 35, 36, 37, 38, and 39, respectively.

The cathode-side separator 60 includes groove passages 61, through which the oxidant gas flows, and groove passages 62, through which the cooling medium flows. The groove passages 61 are arranged in the first surface 60a. The groove passages 62 are arranged in the second surface 60b. FIG. 3 shows, in a simplified manner, parts of an outer edge where the groove passages 61 are formed and parts of an outer edge where the groove passages 62 are formed in the cathode-side separator 60.

The anode-side separator 50 is arranged on an anode electrode side (the rear side in FIG. 3) of the electric power generator 41.

The anode-side separator 50 includes a first surface 50a that faces the electric power generator 41, and a second surface 50b that is opposite the first surface 50a.

The anode-side separator 50 includes through holes 54, 55, 56, 57, 58, and 59 that form the holes 34, 35, 36, 37, 38, and 39, respectively.

The anode-side separator 50 includes groove passages 51, through which the fuel gas flows, and groove passages 52, through which the cooling medium flows. The groove passages 51 are arranged in the first surface 50a. The groove passages 52 are arranged in the second surface 50b. FIG. 3 shows, in a simplified manner, parts of an outer edge where the groove passages 51 are formed and parts of an outer edge where the groove passages 52 are formed in the anode-side separator 50.

As shown in FIG. 2, the case 70 surrounds the outer surfaces of the stack body 32. Attachment portions 73 are arranged on the outer surfaces of the case 70.

The attachment portions 73 include an upper attachment portion 73a arranged on an upper surface of the case 70, and lower attachment portions 73b arranged on a lower surface of the case 70.

One upper attachment portion 73a is arranged in the central part of the upper surface of the case 70 in the lateral direction W.

One lower attachment portion 73b is arranged on each of the two ends of the lower surface of the case 70 in the lateral direction W.

The end plates 71 and 72 close the front and rear openings of the case 70, respectively.

The rear end plate 72 includes through holes 74, 75, 76, 77, 78, and 79 connected to the holes 34, 35, 36, 37, 38, and 39, respectively.

### Connection Mechanism 80

The connection mechanism 80 will now be described in detail.

As schematically shown in FIG. 4, the connection mechanism 80 connects the fuel cell stack 31 in a manner allowing the fuel cell stack 31 to swing relative to the body frame 10. Further, the connection mechanism 80 restricts changes in the orientation of the fuel cell stack 31 so that the tilt of the fuel cell stack 31 is smaller than the bicycle when the bicycle is tilted from a state held upright on a level plane (hereafter, referred to as the upright position).

The connection mechanism 80 includes a suspension 81 connected to the attachment portion 16 and supports 85 connected to the lower frames 14.

The suspension 81 suspends the fuel cell stack 31 in a manner allowing the fuel cell stack 31 to swing relative to the attachment portion 16. Preferably, the suspension 81 is an elastic member. In the present embodiment, the elastic member is a coil spring.

A lower end of the suspension 81 is connected to the upper attachment portion 73a (refer FIG. 3) of the case 70.

The supports 85 support the fuel cell stack 31 in a manner allowing the fuel cell stack 31 to swing relative to the lower frames 14. Preferably, the supports 85 are elastic members. In the present embodiment, the elastic members are coil springs.

Each support 85 is connected to the lower frame 14 and the lower attachment portion 73b (refer FIG. 3) of the case 70.

In the upright position, the inlet hole 36 for guiding cathode gas is located above the outlet hole 37 for discharging the cathode gas.

The operation of the present embodiment will now be described.

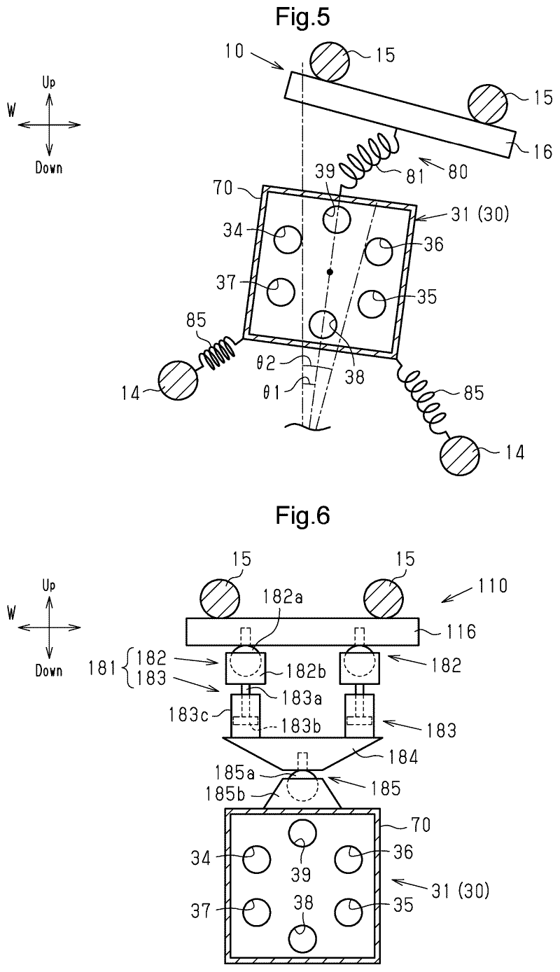

As schematically shown in FIG. 5, when the body frame 10 tilts from the upright position, the connection mechanism 80 swings the fuel cell stack 31 relative to the body frame 10. Thus, an inclination 01 of the fuel cell stack 31 from the upright position is less than an inclination 02 of the body frame 10.

The advantages of the present embodiment will now be described.

(1-1) The connection mechanism 80 connects the fuel cell stack 31 in a manner allowing the fuel cell stack 31 to swing relative to the body frame 10. Further, the connection mechanism 80 restricts changes in the orientation of the fuel cell stack 31 so that the inclination 01 of the fuel cell stack 31 from the upright position is less than the inclination 02 of the body frame 10 from the upright position.

Accordingly, this structure avoids adverse effects on the drainage of generated water that would be caused by tilting of the fuel cell stack 31.

(1-2) The connection mechanism 80 includes the suspension 81, which is connected to the upper frames 15 and suspends the fuel cell stack 31 in a swingable manner.

With this structure, the fuel cell stack 31 swings from the suspension 81. This allows the fuel cell stack 31 to swing relative to the upper frames 15. This effectively utilizes the upper frames 15 of the body frame 10.

(1-3) Preferably, the suspension 81 includes an elastic member.

With this structure, when the body frame 10 is tilted from the upright position, the elastic member is elastically deformed. Thus, the fuel cell stack 31 swings with respect to the body frame 10 so that the inclination 01 of the fuel cell stack 31 from the upright position is less than the inclination 02 of the body frame 10. This simplifies the structure of the connection mechanism 80.

(1-4) The connection mechanism 80 includes the supports 85, which support the fuel cell stack 31 in a manner allowing the fuel cell stack 31 to swing relative to the lower frames 14.

With this structure, the fuel cell stack 31 is supported by the supports 85 so as to be swingable relative to the lower frames 14. Thus, when the body frame 10 tilts from the upright position, the inclination 01 of the fuel cell stack 31 from the upright position readily becomes smaller than the inclination 02 of the body frame 10.

### Second Embodiment

A second embodiment will now be described with reference to FIGS. 6 to 8 focusing on differences from the first embodiment. The present embodiment differs from the first embodiment in the structure of the connection mechanism and in that there are no supports.

In the following description, components of the second embodiment that are the same as or correspond to those in the first embodiment are each denoted with a reference numeral obtained by adding 100 to the reference numeral used in the first embodiment. Such components will not be described in detail.

As shown in FIG. 6, a connection structure 180 includes two upper ball joints 182 spaced apart from each other in the lateral direction W, two extendable cylinders 183, a connecting member 184, and one lower ball joint 185.

### Upper Ball Joints 182

Each upper ball joint 182 includes a ball stud 182a, which is connected to a lower surface of an attachment portion 116, and a socket 182b, which is in spherical contact with a ball of the ball stud 182a.

### Extendable Cylinders 183

Each extendable cylinder 183 includes a rod 183a, which extends downward from the corresponding socket 182b, a piston 183b, which is connected to a lower end of the rod 183a, and a cylinder 183c, which accommodates the piston 183b. The piston 183b is configured to reciprocate in the cylinder 183c.

The lower end of each of the two cylinders 183c is connected to the connecting member 184.

### Lower Ball Joint 185

The lower ball joint 185 includes a ball stud 185a, which is connected to a lower surface of the connecting member 184, and a socket 185b, which is in spherical contact with a ball of the ball stud 185a.

The ball stud 185a is located in the middle of the two upper ball joints 182 at the central part of the bicycle in the lateral direction W. A lower end of the socket 185b is connected to the upper surface of the case 70.

In the present embodiment, each upper ball joint 182 and the corresponding extendable cylinder 183 form a suspension 181.

The operation of the present embodiment will now be described.

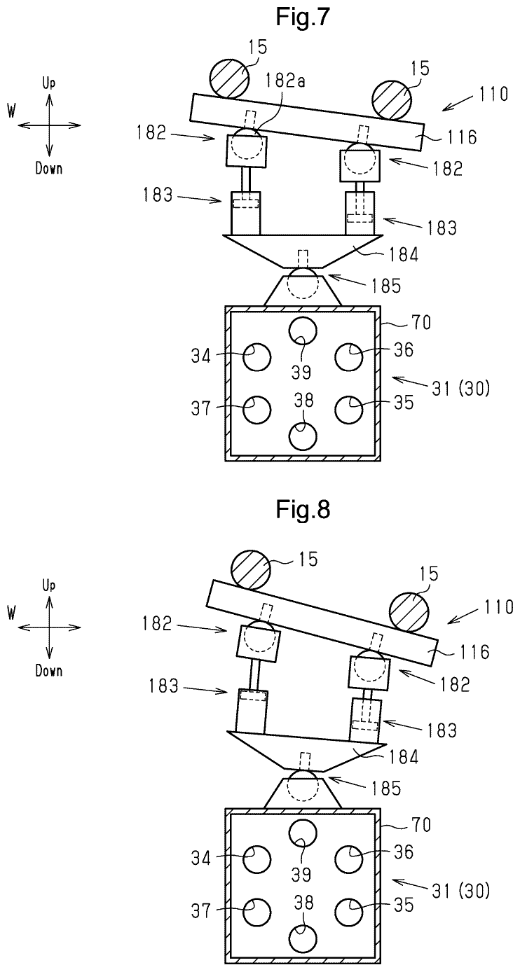

As schematically shown in FIG. 7, when a body frame 110 is tilted from the upright position, the upper ball joints 182 swings the extendable cylinders 183 with respect to the body frame 110. In this case, as the distance changes between each ball stud 182a and the connecting member 184 in the vertical direction Z, the extendable cylinders 183 extend and contract to maintain the orientation of the fuel cell stack 31.

Further, as schematically shown in FIG. 8, when each extendable cylinder 183 is extended to its maximum, the corresponding lower ball joint 185 allows the fuel cell stack 31 to swing with respect to the body frame 110 to maintain the orientation of the fuel cell stack 31.

The advantages of the present embodiment will now be described.

According to the connection structure of the present embodiment, in addition to advantages (1-1) to (1-2) of the first embodiment, the present embodiment has the advantages described below.

(2-1) The connection structure 180 includes the suspensions 181 spaced apart from each other in the lateral direction W.

With this structure, the fuel cell stack 31 is suspended by the suspensions 181, which are spaced apart from each other in the lateral direction W. Thus, when the body frame 110 is tilted from the upright position, the inclination of the fuel cell stack 31 from the upright position readily becomes smaller than the inclination of the body frame 110.

(2-2) The suspensions 181 include the ball joints 182 and 185.

With this structure, when the body frame 110 is tilted from the upright position, the ball joints 182 and 185 allow the fuel cell stack 31 to swing with respect to the body frame 110. Further, the inclination of the of the fuel cell stack 31 from the upright position is less than the inclination of the body frame 110. This simplifies the structure of the connection structure 180.

(2-3) The connection structure 180 includes the suspensions 181 spaced apart from each other in the lateral direction W. Each suspension 181 includes the ball joint 182 and the extendable cylinder 183, which connects the ball joint 182 and the fuel cell stack 31.

With this structure, each suspension 181 includes the ball joint 182 and the extendable cylinder 183. Thus, even though there is more than one ball joint 182, when the body frame 110 tilts from the upright position, the fuel cell stack 31 is allowed to swing with respect to the body frame 110.

### Modifications

The present embodiment may be modified as follows. The present embodiment and the following modifications can be combined as long as there is technical consistency.

In the first embodiment, the supports 85 may be omitted.

In the second embodiment, the lower ball joint 185 may be omitted. In this case, the extendable cylinders 183 may be connected to the upper surface of the case 70.

There may be three or more suspensions.

In the second embodiment, the upper ball joints 182 and the extendable cylinders 183 may be omitted, and the suspension may include the lower ball joint 185 instead.

In each embodiment, the fuel cell stack 31 is suspended from the upper frames 15 by the suspensions 81 and 181. However, the connection mechanism is not limited to such a structure. For example, a connection mechanism may be arranged on the upper surfaces of the lower frames 14 and the case 70 may be supported by the connection mechanism from the lower side. In this case, the connection mechanism may be, for example, a mechanical gyroscope including gimbals.
The stacking direction of the unit cells is not limited to the longitudinal direction L and may be any direction. For example, the stacking direction of the unit cells may be the lateral direction W.

1. A structure for connecting a fuel cell to a body frame of a human-powered electrically assisted vehicle, in which the vehicle to which the structure is applied includes a drive shaft that drives a wheel with human-power, a motor that applies assist drive force to the drive shaft, and the fuel cell that supplies electric power to the motor, the connection structure for the fuel cell in the human-powered electrically assisted vehicle comprising:
a connection mechanism connecting the fuel cell in a manner allowing the fuel cell to swing relative to the body frame and restricting changes in orientation of the fuel cell so that an inclination from an upright position, at which the vehicle is held upright on a level plane, of the fuel cell is less than that of the body frame.

2. The connection structure according to claim 1, wherein
the body frame includes an upper frame located above the fuel cell in a vertical direction, and
the connection mechanism includes at least one suspension that is connected to the upper frame and suspends the fuel cell in a swingable manner.

3. The connection structure according to claim 1, wherein
the connection mechanism includes at least one suspension that suspends the fuel cell in a swingable manner, and
the at least one suspension connected to the body frame and suspends the fuel cell from an upper side.

4. The connection structure according to claim 2, wherein the at least one suspension includes suspensions spaced apart from each other.

5. The connection structure according to claim 2, wherein the at least one suspension includes an elastic member.

6. The connection structure according to claim 2, wherein
the at least one suspension includes a ball joint.

7. The connection structure according to claim 6, wherein
the at least one suspension includes suspensions spaced apart from each other, and
the suspensions each include the ball joint and an extendable cylinder connecting the ball joint and the fuel cell.

8. The connection structure according to claim 2, wherein
the body frame includes a lower frame located below the fuel cell in the vertical direction, and
the connection mechanism includes a support that supports the fuel cell in a manner allowing the fuel cell to swing relative to the lower frame.

9. The connection structure according to claim 3, wherein the at least one suspension includes suspensions spaced apart from each other.

10. The connection structure according to claim 3, wherein the at least one suspension includes an elastic member.

11. The connection structure according to claim 3, wherein the at least one suspension includes a ball joint.

12. The connection structure according to claim 11, wherein
the at least one suspension includes suspensions spaced apart from each other, and
the suspensions each include a ball joint and an extendable cylinder connecting the ball joint and the fuel cell.

13. The connection structure according to claim 3, wherein
the body frame includes a lower frame located below the fuel cell in a vertical direction, and
the connection mechanism includes a support that supports the fuel cell in a manner allowing the fuel cell to swing relative to the lower frame.
